(19) United States
(12) Patent Application Publication
(10) Pub. No.: US 2022/0236380 A1
(43) Pub. Date: Jul. 28, 2022

(54) ROTATING SENSOR ASSEMBLY

(71) Applicant: Ford Global Technologies, LLC, Dearborn, MI (US)

(72) Inventors: Venkatesh Krishnan, Canton, MI (US); Tyler D. Hamilton, Farmington, MI (US); Rashaun Phinisee, Ypsilanti, MI (US); Michael Robertson, JR., Garden City, MI (US); Raghuraman Surineedi, Dearborn, MI (US)

(73) Assignee: Ford Global Technologies, LLC, Dearborn, MI (US)

(21) Appl. No.: 17/160,864

(22) Filed: Jan. 28, 2021

(51) Int. Cl. G01S 7/481; G01S 17/10; G01S 17/931; B60S 1/56; B60R 11/04; B60S 1/48; B60S 1/52

(52) U.S. Cl. CPC G01S 7/4813; G01S 17/10; G01S 7/4817; G01S 17/931; B60R 2011/004; B60R 11/04; B60S 1/481; B60S 1/52; B60S 1/56

(57) ABSTRACT

A sensor assembly includes a base mounted to a vehicle defining a forward direction, a housing mounted to the base and rotatable relative to the base around an axis in a direction of rotation, a sensing apparatus inside the housing and rotatable with the housing, a sensor window fixed to and rotatable with the housing, and a nozzle fixed relative to the base. The sensor window is flat. The sensing apparatus has a field of view through the sensor window. The nozzle is positioned to be aimed at the sensor window when the sensor window is at a first rotational position that is more than 0° and less than 90° from the forward direction relative to the axis in the direction of rotation.

### BACKGROUND

Vehicles, such as autonomous or semi-autonomous vehicles, typically include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back. Some sensors are communications devices, for example, vehicle-to-infrastructure (V2I) or vehicle-to-vehicle (V2V) devices.

### BRIEF DESCRIPTION OF THE DRAWINGS

FIG. 1 is a perspective view of an example vehicle including an example sensor assembly.

FIG. 2 is a perspective of the sensor assembly.

FIG. 3 is a top cross-sectional view of the sensor assembly.

FIG. 4 is a diagram of a control system and cleaning system of the sensor assembly.

FIG. 5 is a top view of a portion of the vehicle including the sensor assembly.

FIG. 6 is a side view of a nozzle of the sensor assembly.

### DETAILED DESCRIPTION

A sensor assembly includes a base mounted to a vehicle defining a forward direction, a housing mounted to the base and rotatable relative to the base around an axis in a direction of rotation, a sensing apparatus inside the housing and rotatable with the housing, a sensor window fixed to and rotatable with the housing, the sensor window being flat, and a nozzle fixed relative to the base. The sensing apparatus has a field of view through the sensor window. The nozzle is positioned to be aimed at the sensor window when the sensor window is at a first rotational position that is more than 0° and less than 90° from the forward direction relative to the axis in the direction of rotation.

The sensor assembly may lack nozzles positioned to be aimed at the sensor window when the sensor window is more than 90° and less than 360° from the forward direction relative to the axis in the direction of rotation.

The nozzle may be positioned below a lowest point of the housing.

The nozzle may be a first nozzle, the sensor assembly may further include a second nozzle fixed relative to the base and positioned to be aimed at the sensor window when the sensor window is at a second rotational position that is more than 0° and less than 90° from the forward direction relative to the axis in the direction of rotation. The second rotational position may be the same as the first rotational position.

The sensor assembly may further include a motor arranged to rotate the housing in the direction of rotation relative to the base. The sensor assembly may further include a computer communicatively coupled to the motor, and the computer may be programmed to instruct the motor to rotate the housing in the direction of rotation at a constant speed. The sensor assembly may further include a valve actuatable to control fluid flow to the nozzle, the computer may be communicatively coupled to the valve and programmed to instruct the valve to open for an activation period, and the activation period may be at least two full rotations of the housing at the constant speed.

The sensor window may be rectangular. The nozzle may define a spray angle extending from a bottom to a top of the sensor window when the sensor window is in the first rotational position.

The sensor window may extend from the housing in a direction that is radially outward and circumferential relative to the axis.

The sensor window may extend circumferentially around the axis for at most 45°.

The sensor window may be one of at least one sensor window, and the at least one sensor window may collectively extend circumferentially around the axis for at most 90°. The at least one sensor window may include two sensor windows, and each of the sensor windows may extend for at most 45°. The two sensor windows may be rotationally symmetrically by 180° around the axis with respect to each other.

The sensor window may be recessed in the housing.

The housing may have a constant cross-section along the axis from a bottom of the sensor window to a top of the sensor window.

With reference to the Figures, a sensor assembly 102 includes a base 104 mounted to a vehicle 100 defining a forward direction F, a housing 106 mounted to the base 104 and rotatable relative to the base 104 around an axis A in a direction of rotation D, a sensing apparatus 108 inside the housing 106 and rotatable with the housing 106, a sensor window 110 fixed to and rotatable with the housing 106, and a nozzle 130 fixed relative to the base 104. The sensor window 110 is flat. The sensing apparatus 108 has a field of view through the sensor window 110. The nozzle 130 is positioned to be aimed at the sensor window 110 when the sensor window 110 is at a first rotational position that is more than 0° and less than 90° from the forward direction F relative to the axis A in the direction of rotation D.

The sensor assembly 102 provides for efficient cleaning of the sensor window 110 while minimizing the effect of washer fluid on the sensor window 110. The fact that the sensor window 110 rotates obviates a need to have nozzles encircling the housing 106; instead, the nozzle 130 can be located at a particular location and spray the sensor window 110 as the housing 106 makes each revolution. The fact that the nozzle 130 is positioned to spray the sensor window 110 when the sensor window 110 is at the first rotational position, as opposed to other circumferential positions that the nozzle 130 could occupy, provides a longer time for the sensor window 110 to dry before the sensor window 110 faces in the forward direction F, specifically at least the time required to rotate 270°. In other words, spray from the nozzle 130 strikes the sensor window 110 when the sensor window 110 is less than a quarter rotation since facing straight forward, so the sensor window 110 has more than three quarters of a rotation before facing straight forward again. Data from the sensing apparatus 108 is comparatively more important in the forward direction F than other directions because the vehicle 100 most frequently travels in the forward direction F.

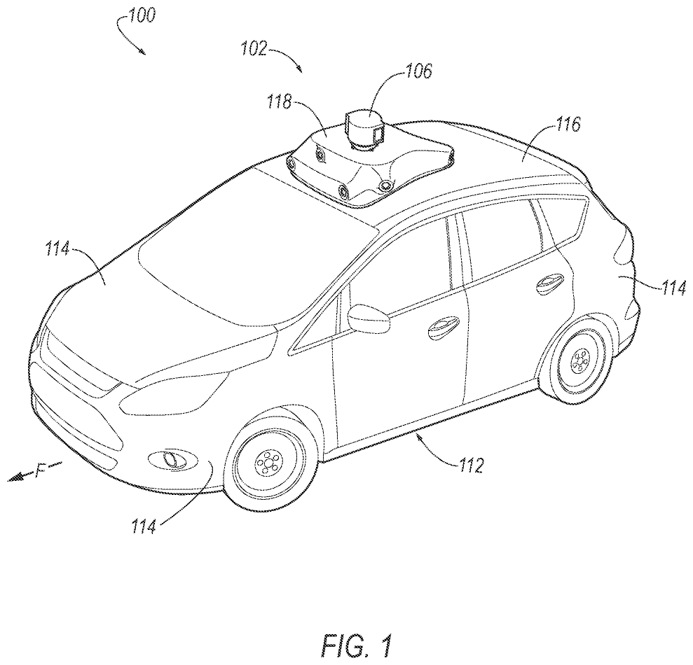

With reference to FIG. 1, the vehicle 100 may be any suitable type of automobile, e.g., a passenger or commercial automobile such as a sedan, a coupe, a truck, a sport utility vehicle, a crossover vehicle, a van, a minivan, a taxi, a bus, etc. The vehicle 100, for example, may be an autonomous vehicle. In other words, the vehicle 100 may be autonomously operated such that the vehicle 100 may be driven without constant attention from a driver, i.e., the vehicle 100 may be self-driving without human input. Autonomous operation can be based in part on data received from the sensor assembly 102.

The vehicle 100 includes a vehicle body 112. The vehicle body 112 includes body panels 114 partially defining an exterior of the vehicle 100. The body panels 114 may present a class-A surface, e.g., a finished surface exposed to view by a customer and free of unaesthetic blemishes and defects. The body panels 114 include, e.g., a roof 116, etc.

A casing 118 for the sensor assembly 102 and other sensors is attachable to the vehicle 100, e.g., to one of the body panels 114 of the vehicle 100, e.g., the roof 116. For example, the casing 118 may be shaped to be attachable to the roof 116, e.g., may have a shape matching a contour of the roof 116. The casing 118 may be attached to the roof 116, which can provide the first sensing apparatus 108a and a second sensing apparatus 108b of the sensor assembly 102 with an unobstructed field of view of an area around the vehicle 100. The casing 118 may be formed of, e.g., plastic or metal. The sensor assembly 102 is supported by the casing 118. The sensor assembly 102 can be disposed on top of the casing 118 at a highest point of the casing 118.

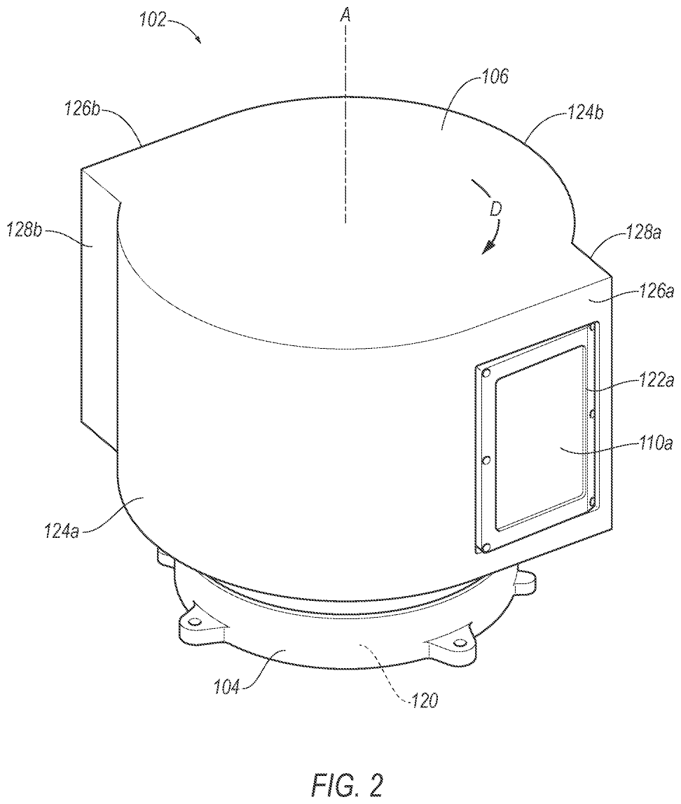

With reference to FIG. 2, the sensor assembly 102 includes the base 104. The base 104 is attached to the casing 118 on top of the casing 118. The base 104 can be bolted to the casing 118, e.g., through bolt holes in the base 104. The base 104 is mounted to the vehicle 100, e.g., via the casing 118, and the vehicle 100 defines a forward direction F, i.e., a direction of forward travel for the vehicle 100.

The sensor assembly 102 includes a motor 120. The motor 120 is arranged to drivably rotate the housing 106 in the direction of rotation D about the axis A. The motor 120 can be positioned, e.g., inside the base 104. The motor 120 can be, e.g., an electric motor.

The housing 106 is mounted to the base 104 and rotatable relative to the base 104 around the axis A in the direction of rotation D. For example, the housing 106 can be mounted, e.g., fastened, to a sensor body (not shown). The sensor body can be rotatably attached to the base 104 and drivable by the motor 120. The housing 106 can cover a top and sides of the sensor body.

The sensing apparatuses 108 are disposed inside the housing 106 and are rotatable with the housing 106. For example, the sensing apparatuses 108 are mounted to and fixed relative to the sensor body, and thereby fixed relative to the housing 106. The second sensing apparatus 108b can be a same type of sensor as the first sensing apparatus 108a. The sensing apparatuses 108 may be designed to detect features of the outside world; for example, the sensing apparatuses 108 may be radar sensors, scanning laser range finders, light detection and ranging (LIDAR) devices, or image processing sensors such as cameras. In particular, the sensing apparatuses 108 may be LIDAR devices, e.g., scanning LIDAR devices. A LIDAR device detects distances to objects by emitting laser pulses at a particular wavelength and measuring the time of flight for the pulse to travel to the object and back. The first sensing apparatus 108a has a field of view through the first sensor window 110a encompassing a region from which the first sensing apparatus 108a receives input, and the second sensing apparatus 108b has a field of view through a second sensor window 110b encompassing a region from which the second sensing apparatus 108b receives input. As the sensing apparatuses 108 rotate with the housing 106, the fields of view encompass a horizontal 360° around the vehicle 100.

The sensor assembly 102 can include at least one sensor window 110, e.g., two sensor windows 110. The sensor windows 110 are fixed relative to the housing 106 and rotatable with the housing 106. The housing 106 includes respective openings 122, e.g., a first opening 122a and a second opening 122b, in which the sensor windows 110 are positioned.

The sensor windows 110 have a collective circumferential extent around the axis A, that is, a collective angular sweep covered by the sensor windows 110. The circumferential extent around the axis A of each sensor window 110 is an angle θ formed at the axis A between a clockwisemost point and a counterclockwisemost point of that sensor window 110, i.e., an angular sweep around the axis A from one circumferential end of that sensor window 110 to the other circumferential end of that sensor window 110. For example, the sensor windows 110 can collectively extend circumferentially around the axis A for at most 90°. The first sensor window 110a and the second sensor window 110b can each extend circumferentially around the axis A for at most 45°. The comparatively small angular sweep of the sensor windows 110 with respect to the housing 106 provides a small area to keep clean and is accommodated by the fact that the housing 106 and the sensor windows 110 rotate.

The sensor windows 110 can be flat. For example, the sensor windows 110 can have a rectangular shape. The sensor windows 110 are transparent with respect to whatever medium the sensing apparatuses 108 are capable of detecting. For example, if the sensing apparatuses 108 are LIDAR devices, then the sensor windows 110 are transparent with respect to visible light at the wavelength generated and detectable by the sensing apparatuses 108.

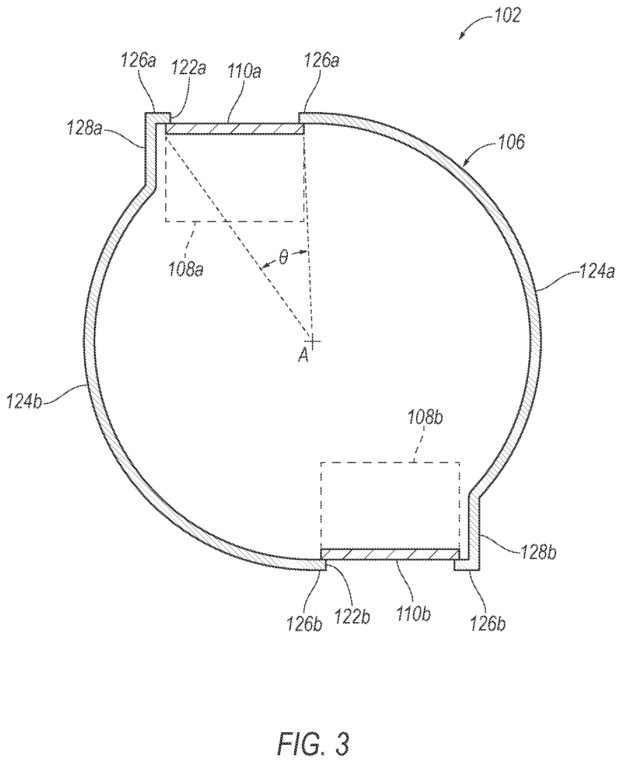

With reference to FIG. 3, the housing 106 includes at least one outer wall 124, at least one window wall 126, and at least one nonwindow wall 128. For example, the housing 106 includes a first outer wall 124a, a first window wall 126a, a first nonwindow wall 128a, a second outer wall 124b, a second window wall 126b, and a second nonwindow wall 128b.

The housing 106 can be rotationally symmetric, e.g., second-degree rotationally symmetric. For the purposes of this disclosure, “rotationally symmetric” means looking the same after some rotation by a partial turn around an axis A. A degree of rotational symmetry is a number of distinct orientations in which something looks the same for each rotation. The housing 106 has second-degree rotational symmetry, and the housing 106 looks the same when rotated by 180° so that the second outer wall 124b, the second window wall 126b, and the second nonwindow wall 128b occupy the space previously occupied by the first outer wall 124a, the first window wall 126a, and the first nonwindow wall 128a, respectively. Specifically, the second outer wall 124b, the second window wall 126b, and the second nonwindow wall 128b are rotationally symmetric by 180° around the axis A with respect to the first outer wall 124a, the first window wall 126a, and the first nonwindow wall 128a, respectively. The sensor windows 110 are also rotationally symmetric by 180° around the axis A with respect to each other. The following descriptions of the first outer wall 124a, the first window wall 126a, the first sensor window 110a, and the first nonwindow wall 128a apply as well to the second outer wall 124b, the second window wall 126b, the second sensor window 110b, and the second nonwindow wall 128b, respectively.

The first outer wall 124a has a partial cylindrical shape extending circumferentially at a constant outer radius from the axis A. The first outer wall 124a extends circumferentially at the constant outer radius from the second nonwindow wall 128b to the first window wall 126a. The first outer wall 124a extends circumferentially for at least 90°. Because of the constant outer radius, the rotational motion of the first outer wall 124a does not displace air for the circumferential extent of the first outer wall 124a, providing smooth airflow onto the first nonwindow wall 128a. The first outer wall 124a extends vertically, i.e., parallel to the axis A, from below the sensor windows 110 to above the sensor windows 110.

The first window wall 126a is flat and parallel to the first sensor window 110a. The first window wall 126a extends completely around the first sensor window 110a, i.e., below, above, and to the sides. The first window wall 126a includes the first opening 122a in which the first sensor window 110a is positioned. The first window wall 126a extends from the first outer wall 124a to the first nonwindow wall 128a. The first window wall 126a extends in a direction tangent to the first outer wall 124a. The first window wall 126a extends vertically, i.e., parallel to the axis A, from below the first sensor window 110a to above the first sensor window 110a.

The first sensor window 110a is parallel to the first window wall 126a. The first sensor window 110a is recessed in the first window wall 126a. The first sensor window 110a extends from a point on the housing 106, e.g., the point on the first opening 122a that is closest to the axis A, which is also a point nearest the first outer wall 124a, in a direction that is radially outward and circumferential relative to the axis A. The first sensor window 110a is disposed farther from the axis A than the outer radius of the first outer wall 124a. An exterior surface of the first sensor window 110a faces in a direction that is radially outward and circumferentially in the direction of rotation D relative to the axis A. For the purposes of this disclosure, a direction that a surface “faces” is a direction that is normal, i.e., perpendicular or orthogonal, to that surface.

The first nonwindow wall 128a extends from the first window wall 126a to the second outer wall 124b. The first nonwindow wall 128a can be flat. The first nonwindow wall 128a extends in a radially inward direction and possibly a circumferential direction from the first window wall 126a relative to the axis A. The first nonwindow wall 128a can be nontangent to the second outer wall 124b. An exterior surface of the first nonwindow wall 128a faces in a direction that is radially outward and circumferentially away from the direction of rotation D relative to the axis A. The first nonwindow wall 128a extends vertically, i.e., parallel to the axis A, from below the sensor windows 110 to above the sensor windows 110.

The housing 106, specifically the first outer wall 124a, the first window wall 126a, the first nonwindow wall 128a, the second outer wall 124b, the second window wall 126b, and the second nonwindow wall 128b, can have a constant cross-section from a bottom of the sensor windows 110 to a top of the sensor windows 110. Except for the openings 122, the housing 106 can have a constant cross-section from a distance below the sensor windows 110 to a distance above the sensor windows 110. The constant cross-section can reduce forces tending to roll or pitch the housing 106 as the housing 106 rotates.

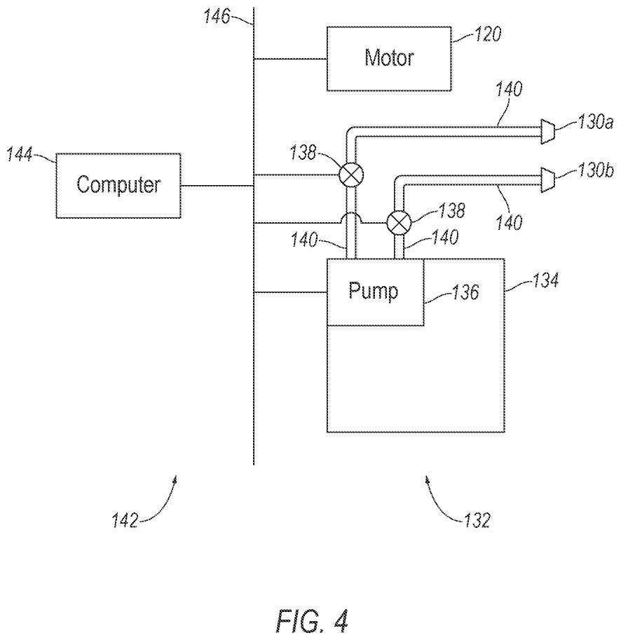

With reference to FIG. 4, the sensor assembly 102 includes a cleaning system 132 of the vehicle 100. The cleaning system 132 includes a reservoir 134, a pump 136, valves 138, supply lines 140, and the nozzles 130. The reservoir 134, the pump 136, and the nozzles 130 are fluidly connected to each other (i.e., fluid can flow from one to the other). The cleaning system 132 distributes washer fluid stored in the reservoir 134 to the nozzles 130. “Washer fluid” is any liquid stored in the reservoir 134 for cleaning. The washer fluid may include solvents, detergents, diluents such as water, etc.

The reservoir 134 may be a tank fillable with liquid, e.g., washer fluid for window cleaning. The reservoir 134 may be disposed in the casing 118. Alternatively, the reservoir 134 may be disposed at a front of the vehicle 100, specifically, in an engine compartment forward of a passenger cabin. The reservoir 134 may store the washer fluid only for supplying the sensor assembly 102 or also for other purposes, such as supply to the windshield.

The pump 136 may force the washer fluid through the supply lines 140 to the nozzles 130 with sufficient pressure that the washer fluid sprays from the nozzles 130. The pump 136 is fluidly connected to the reservoir 134. The pump 136 may be attached to or disposed in the reservoir 134.

Each valve 138 is positioned and actuatable to control fluid flow from the pump 136 to one of the nozzles 130. Specifically, fluid from the supply lines 140 from the pump 136 must flow through one of the valves 138 to reach the respective supply line 140 providing fluid to the respective nozzle 130. The valves 138 control flow by being actuatable between an open position permitting flow and a closed position blocking flow from the incoming to the outgoing of the supply lines 140. The valves 138 can be solenoid valves. As a solenoid valve, each valve 138 includes a solenoid and a plunger. Electrical current through the solenoid generates a magnetic field, and the plunger moves in response to changes in the magnetic field. The solenoid moves the plunger between a position in which the valve 138 is open and a position in which the valve 138 is closed.

The supply lines 140 extend from the pump 136 to the nozzles 130. The supply lines 140 may be, e.g., flexible tubes.

As described in more detail below, the nozzles 130 are positioned to eject washer fluid onto the sensor assembly 102, either the housing 106 or one of the sensor windows 110, depending on the rotational position of the sensor windows 110.

The sensor assembly 102 includes a control system 142. The control system 142 includes a computer 144 and a communications network 146. The computer 144 is a microprocessor-based computing device, e.g., a generic computing device including a processor and a memory, an electronic controller or the like, a field-programmable gate array (FPGA), an application-specific integrated circuit (ASIC), etc. The computer 144 can thus include a processor, a memory, etc. The memory of the computer 144 can include media for storing instructions executable by the processor as well as for electronically storing data and/or databases, and/or the computer 144 can include structures such as the foregoing by which programming is provided. The computer 144 can be multiple computers coupled together.

The computer 144 may transmit and receive data through the communications network 146. For example, the communications network 146 can be a controller area network (CAN) bus, Ethernet, WiFi, Local Interconnect Network (LIN), onboard diagnostics connector (OBD-II), and/or by any other wired or wireless communications network. The computer 144 may be communicatively coupled to the motor 120, the pump 136, the valves 138, and other components via the communications network 146.

The computer 144 is programmed to control the motor 120. Specifically, the computer 144 is programmed to instruct the motor 120 to rotate the housing 106 at a constant speed. The speed of the motor 120 can be chosen based on a scanning speed of the sensing apparatuses 108 in order to quickly refresh data about the environment around the vehicle 100 while permitting the sensing apparatuses 108 to have complete coverage of the environment during rotation, e.g., 600 revolutions per minute.

The computer 144 is programmed to control the cleaning system 132, specifically the pump 136 and the valves 138. The computer 144 can instruct the cleaning system 132 to run a cleaning cycle in response to a cleaning trigger. For the purposes of this disclosure, a “cleaning trigger” is an event indicating that the sensor windows 110 should be cleaned. A first example of a cleaning trigger is an input from an operator of the vehicle 100. A second example is data from the sensing apparatuses 108 indicating an obstruction of one of the sensor windows 110, such as a region of the field of view being unchanging across different rotational positions of the sensor window 110. A third example is a preset duration elapsing since the last cleaning. The preset duration can be chosen based on testing the sensor assembly 102 to determine how long can run before becoming sufficiently dirty that data from the sensing apparatuses 108 are affected. The cleaning cycle is running the pump 136, opening the valves 138, closing the valves 138, and stopping the pump 136. By default, i.e., when a cleaning cycle is not occurring, the pump 136 is not running, and the valves 138 are closed. Specifically, the computer 144 is programmed to, in response to a cleaning trigger, instruct the pump 136 to run, instruct the valves 138 to open for an activation period and then close, and instruct the pump 136 to stop running upon the valves 138 closing. The activation period is a duration that the valves 138 remain open before closing. The activation period is chosen based on a speed of operation of the valves 138. The activation period lasts for multiple rotations of the housing 106, i.e., is at least two full rotations of the housing 106 at the constant speed.

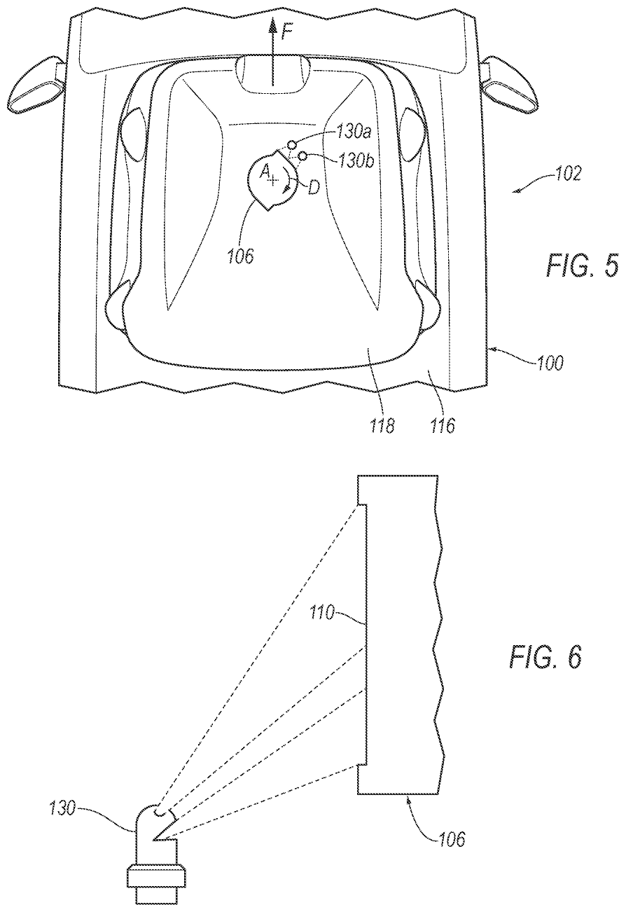

With reference to FIG. 5, the nozzles 130 are fixed relative to the base 104. For example, the nozzles 130 are attached to an exterior of the casing 118 and are radially spaced from the housing 106 relative to the axis A. The nozzles 130 can include a first nozzle 130a, a second nozzle 130b, and possibly additional nozzles 130 (not shown). The first nozzle 130a is positioned to be aimed at the sensor window 110 when the sensor window 110 is at a first rotational position that is more than 0° and less than 90° from the forward direction F relative to the axis A in the direction of rotation D. (The first rotational position is the same for each sensor window 110 because the sensor windows 110 are rotationally symmetric.) In other words, spray from the first nozzle 130a strikes the sensor window 110 when the sensor window 110 is less than a quarter rotation since facing straight forward. The second nozzle 130b is positioned to be aimed at the sensor window 110 when the sensor window 110 is at a second rotational position that is more than 0° and less than 90° from the forward direction F relative to the axis A in the direction of rotation D. The second rotational position can be the same as the first rotational position so that the force of spray from multiple nozzles 130 strikes the sensor window 110 simultaneously. Alternatively, the second rotational position can be circumferentially offset from the first rotational position so that spray from the nozzles 130 strikes the sensor window 110 for a longer total duration. Additional nozzles 130 are positioned to be aimed at the sensor window 110 when the sensor window 110 is at respective additional positions that are more than 0° and less than 90° from the forward direction F relative to the axis A in the direction of rotation D. The additional rotational positions can be the same as the first or second rotational positions or circumferentially offset from the first or second rotational positions. The sensor assembly 102 lacks nozzles positioned to be aimed at the sensor window 110 when the sensor window 110 is more than 90° and less than 360° from the forward direction F relative to the axis A in the direction of rotation D, thereby permitting the sensor window 110 time to dry before facing the forward direction F.

With reference to FIG. 6, the nozzles 130 are positioned below a lowest point of the housing 106. The nozzles 130 are shaped to spray upward at the sensor windows 110. The nozzles 130 each define a spray angle extending from a bottom to a top of the sensor window 110 when the sensor window 110 is in the first or second rotational position, respectively. In other words, the spray from the nozzles 130 strikes a full height of the sensor window 110.

In operation, the motor 120 rotates the housing 106 and sensor windows 110 at the constant speed while the vehicle 100 is operating. When a cleaning trigger occurs, the cleaning system 132 performs a cleaning cycle. The nozzles 130 spray at the respective first or second rotational position for the activation period. During the activation period, the sensor windows 110 rotate completely around the axis A multiple times. During each rotation, each sensor window 110 passes through the first and second rotational positions, at which the spray from the first and second nozzles 130 strikes the sensor window 110 and washes off debris or dirt. After each time passing the first and second rotational positions, the sensor windows 110 rotate more than three quarters of a rotation before facing straight forward, during which the airflow across the sensor windows 110 and the centrifugal force from the rotation forces the washer fluid off of the sensor windows 110. The sensor windows 110 are thus dried when facing forward even during the activation period. The activation period ends, and the nozzles 130 stop spraying.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. A sensor assembly comprising:
a base mounted to a vehicle defining a forward direction;
a housing mounted to the base and rotatable relative to the base around an axis in a direction of rotation;
a sensing apparatus inside the housing and rotatable with the housing;
a sensor window fixed to and rotatable with the housing, the sensor window being flat; and
a nozzle fixed relative to the base;
wherein the sensing apparatus has a field of view through the sensor window; and
the nozzle is positioned to be aimed at the sensor window when the sensor window is at a first rotational position that is more than 0° and less than 90° from the forward direction relative to the axis in the direction of rotation.

2. The sensor assembly of claim 1, wherein the sensor assembly lacks nozzles positioned to be aimed at the sensor window when the sensor window is more than 90° and less than 360° from the forward direction relative to the axis in the direction of rotation.

3. The sensor assembly of claim 1, wherein the nozzle is positioned below a lowest point of the housing.

4. The sensor assembly of claim 1, wherein the nozzle is a first nozzle, the sensor assembly further comprising a second nozzle fixed relative to the base and positioned to be aimed at the sensor window when the sensor window is at a second rotational position that is more than 0° and less than 90° from the forward direction relative to the axis in the direction of rotation.

5. The sensor assembly of claim 4, wherein the second rotational position is the same as the first rotational position.

6. The sensor assembly of claim 1, further comprising a motor arranged to rotate the housing in the direction of rotation relative to the base.

7. The sensor assembly of claim 6, further comprising a computer communicatively coupled to the motor, wherein the computer is programmed to instruct the motor to rotate the housing in the direction of rotation at a constant speed.

8. The sensor assembly of claim 7, further comprising a valve actuatable to control fluid flow to the nozzle, wherein the computer is communicatively coupled to the valve and programmed to instruct the valve to open for an activation period, and the activation period is at least two full rotations of the housing at the constant speed.

9. The sensor assembly of claim 1, wherein the sensor window is rectangular.

10. The sensor assembly of claim 9, wherein the nozzle defines a spray angle extending from a bottom to a top of the sensor window when the sensor window is in the first rotational position.

11. The sensor assembly of claim 1, wherein the sensor window extends from the housing in a direction that is radially outward and circumferential relative to the axis.

12. The sensor assembly of claim 1, wherein the sensor window extends circumferentially around the axis for at most 45°.

13. The sensor assembly of claim 1, wherein the sensor window is one of at least one sensor window, and the at least one sensor window collectively extends circumferentially around the axis for at most 90°.

14. The sensor assembly of claim 13, wherein the at least one sensor window includes two sensor windows, and each of the sensor windows extends for at most 45°.

15. The sensor assembly of claim 14, wherein the two sensor windows are rotationally symmetrically by 180° around the axis with respect to each other.

16. The sensor assembly of claim 1, wherein the sensor window is recessed in the housing.

17. The sensor assembly of claim 1, wherein the housing has a constant cross-section along the axis from a bottom of the sensor window to a top of the sensor window.
